(19) United States
(12) Patent Application Publication
(10) Pub. No.: US 2013/0326875 A1
(43) Pub. Date: Dec. 12, 2013

(54) METHOD AND APPARATUS FOR ROLL-IN AND ALIGNMENT OF A CASING SHELL OF A GAS TURBINE

(71) Applicants: Kenneth Damon Black, Travelers Rest, SC (US); Matthew Stephen Casavant, Greenville, SC (US); Brett Darrick Klingler, Greenville, SC (US)

(72) Inventors: Kenneth Damon Black, Travelers Rest, SC (US); Matthew Stephen Casavant, Greenville, SC (US); Brett Darrick Klingler, Greenville, SC (US)

(73) Assignee: GENERAL ELECTRIC COMPANY, Schenectady, NY (US)

(21) Appl. No.: 13/492,297

(22) Filed: Jun. 8, 2012

(51) Int. Cl. B23P 19/04; B23P 17/00

(52) U.S. Cl. 29/888.01; 29/240

(57) ABSTRACT

A method and apparatus for rolling and aligning a casing of a gas turbine is disclosed. At least one jack having a roller at one end is positioned at a location to couple the roller to the casing. The casing is rolled within the turbine by rolling over the roller of the at least one jack. The roller is moved relative to the at least one jack to align the casing within the turbine.

### BACKGROUND OF THE INVENTION

The subject matter disclosed herein relates to a jacking tool that can be used to perform roll-in and alignment of inner turbine shells for gas turbines. Several gas turbine sections include an outer turbine shell and an inner turbine shell which are separable into upper and lower halves that can be opened for maintenance or repair. It is often desired to separate the inner turbine shell from the outer turbine shell for maintenance work at separate locations and afterwards to reinstall the inner turbine shell within the outer turbine shell, a procedure that requires realigning the inner turbine shell with an axis of a turbine rotor. Current methods for installing and aligning the inner turbine shell uses one set of tools for removal/installation and another set of tools for alignment to the rotor. This can be clumsy as well as time-consuming. The present disclosure invention therefore provides an apparatus that can be used for both installation/removal and alignment of the inner turbine shell.

### BRIEF DESCRIPTION OF THE INVENTION

According to one aspect, the present disclosure provides a method of rolling and aligning a casing in a turbine location, including: positioning at least one jack having a roller at one end to a location to couple the roller to the casing; rolling the casing over the roller; and moving the roller relative to the jack to align the casing.

According to another aspect, the present disclosure provides an apparatus for rolling and aligning a casing of a gas turbine, including: at least one jack configured to couple to the casing at a contact point and to move the casing to align the casing; and a roller at an end of the jack at the contact point configured to roll the casing.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 shows an exemplary apparatus for installation and alignment of a casing in one aspect of the present disclosure;

FIG. 2 shows a roller head of the exemplary apparatus in an alternate embodiment of the present disclosure;

FIG. 3 shows a profile view of an outer turbine shell of a turbine;

FIG. 4 shows an exemplary drive system usable during assembly and disassembly procedures of the inner turbine shell in one embodiment of the present disclosure;

FIGS. 5-8 illustrate a method of roll-in and alignment of an inner turbine shell using the exemplary apparatus of the present disclosure; and

FIG. 9 illustrates a method of aligning a centerline of an inner turbine shell with a rotor axis using the exemplary apparatus of the present disclosure.

The detailed description explains embodiments of the invention, together with advantages and features, by way of example with reference to the drawings.

### DETAILED DESCRIPTION OF THE INVENTION

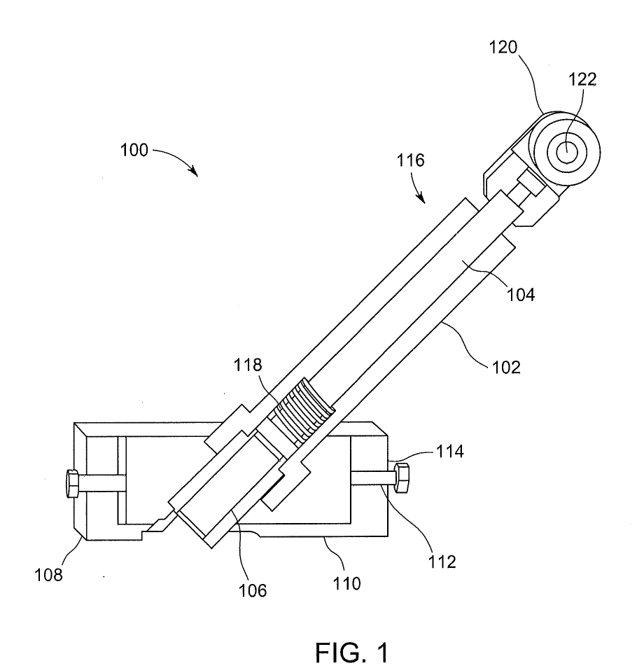

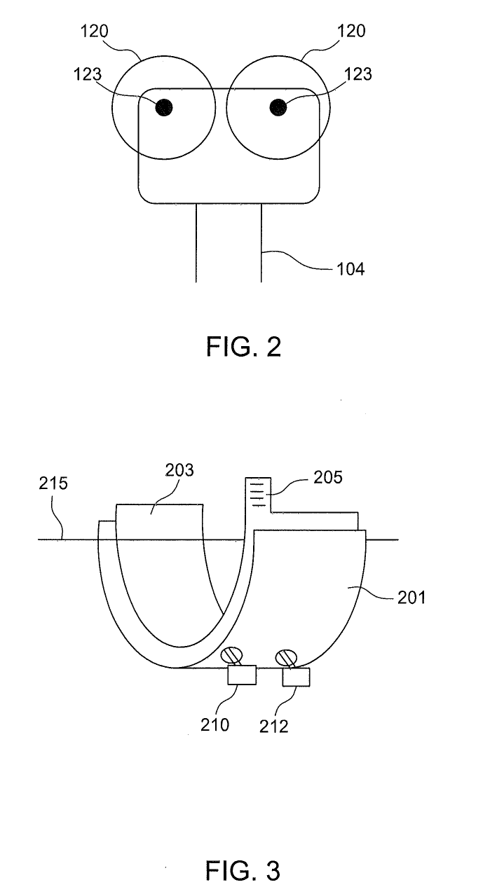

FIG. 1 shows an exemplary apparatus 100 usable for installation and alignment of a casing such as inner turbine shell in one aspect of the present disclosure. The apparatus 100, generally referred to herein as a roller jack, includes a housing 102 and a member 104 configured to slide within the housing. In an exemplary embodiment, the housing 102 is a hollow cylinder and the member 104 is a cylinder that has an outer diameter less than an inner diameter of the housing and thus is configured to slide along a longitudinal axis of the housing 102. The housing 102 is secured to a sliding block 110 at a first end 114 of the housing. The sliding block 110 is configured to move laterally within a base 108. The base 108 may be secured to enable the apparatus to provide a support to a casing during installation and alignment procedures. The base 108 is generally secured on a flat surface such as a floor and the lateral motion of the sliding block 110 within the base 108 is therefor in a plane parallel to the floor surface. One or more position adjustment devices 112 such as screws can be manipulated to move the sliding block 110 laterally within the base 108, thereby enabling an operator to position the housing 102 at a selected location. A hydraulic device 106 and spring 118 are located inside the housing at the first end 114. The hydraulic device 106 is coupled to the member 104 at the first end and is configured to move the member along the longitudinal axis of the housing. A roller or bearing 120 is coupled to the member 104 at a second end distal to the hydraulic device. In an exemplary embodiment, the roller 120 is coupled to the member via a pin 122. Pin 122 has a longitudinal axis that is oriented transverse to the longitudinal axis of the member 104. In general, the longitudinal axis of the housing 102 and member 104 are oriented at a 45-degree angle with respect to the lateral direction defined by the direction of motion of the sliding base 108. However, any selected angle of orientation can be used in various embodiments of the present disclosure. Although a single roller is shown in the embodiment of FIG. 1, in various alternate embodiments, two or more rollers can be coupled to the member, as illustrated in FIG. 2.

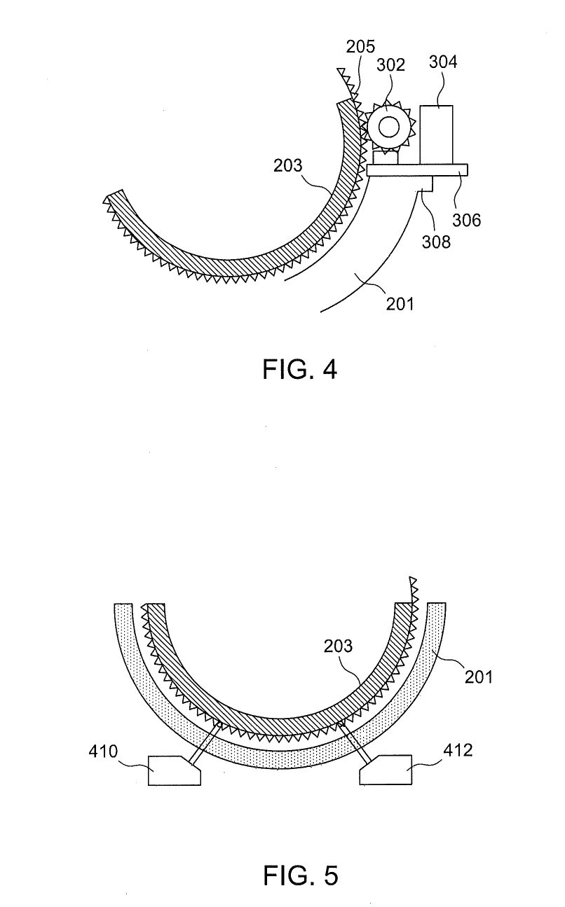

FIG. 3 shows a profile view of an outer turbine shell of a turbine. In various aspects, an exemplary roller jack 100 of FIG. 1 is used to install or roll-in a casing such as an inner turbine shell or an inner compressor casing with respect to the outer turbine shell. For illustrative purposes, the casing is referred to herein as an inner turbine shell. A counterweight 203 is shows positioned in the outer turbine shell 201 in preparation for rolling of a lower inner turbine into position within the outer turbine shell 201. In general, the outer turbine shell 201 and the counterweight 203 are semicircular in shape. The counterweight 203 includes a counterweight gear 205 along its perimeter for motive engagement with a motive gear (as shown in FIG. 4). The counterweight gear extends beyond the semicircular shape of the counterweight in order to engage the motive gear at a location unimpeded by the outer turbine shell 201.

Exemplary roller jack 210 and exemplary roller jack 212 are positioned at fore and aft locations, respectively, with respect to the outer turbine shell 201. Another set of fore roller jack and aft roller jack are placed at opposed to roller jacks 210 and 212 with respect to a vertical plane that encompasses centerline 215 of the counterweight, which is aligned along a longitudinal axis of the inner turbine shell. In alternate embodiments, more or less roller jacks can be used. The outer turbine shell 201 includes one or more gaps or holes that allow the members 104 of the various roller jacks to pass from an outer space of the outer turbine shell to an inner space of the outer turbine shell. The member extends through the gap or hole to bring the roller 120 into rolling engagement with the counterweight 403 at the outer surface of the counterweight. The member 104 can be further extended to elevate the counterweight 203 away from the outer turbine shell, thereby providing a separation between the counterweight 203 and the outer turbine shell 201. In general, the one or more roller jacks 210 and 212 engage the counterweight 203 at a location away from the counterweight gear 205.

Also shown in FIG. 3 is a centerline 215 of the counterweight 203. The axis of pin 122 (FIG. 1) is aligned parallel to this centerline 215 during rolling in and out of the inner turbine shell. Additionally, the longitudinal axis of the member 104 is generally aligned along a radial line extending from the centerline during roll-in, roll-out and alignment procedures. Thus the roller jack 100 can be used to control radial movement of the inner turbine shell as well as provide rotation of the inner turbine shell.

FIG. 4 shows an exemplary drive system 302 used during assembly and disassembly procedures of the inner turbine shell in one embodiment of the present disclosure. Various exemplary drive systems can include a system that actuates a motive gear for providing motion to the inner turbine shell, a friction drive system, or a chain drive system. However, the drive system is not limited the exemplary drive systems disclosed herein and can be any drive system suitable for causing a rotation of the inner turbine shell. For illustrative purposes, the drive system is referred to herein as a motive gear. The exemplary motive gear 302 is powered by motor 304 which is secured to a base plate 306. In various embodiments, the base plate 306 can be secured to the outer turbine shell 201, generally at a flange portion 308 of the outer turbine shell 201. The motive gear is configured to mate with counterweight gear 205 of counterweight 203 to enable rotation of the counterweight 203 about its centerline. The motive gear 302 can be operated to rotate in either a clockwise or a counterclockwise direction, thereby causing the counterweight 203 and/or inner turbine shell to be either rolled into or out of the outer turbine shell 201, as illustrated below in FIGS. 5-8.

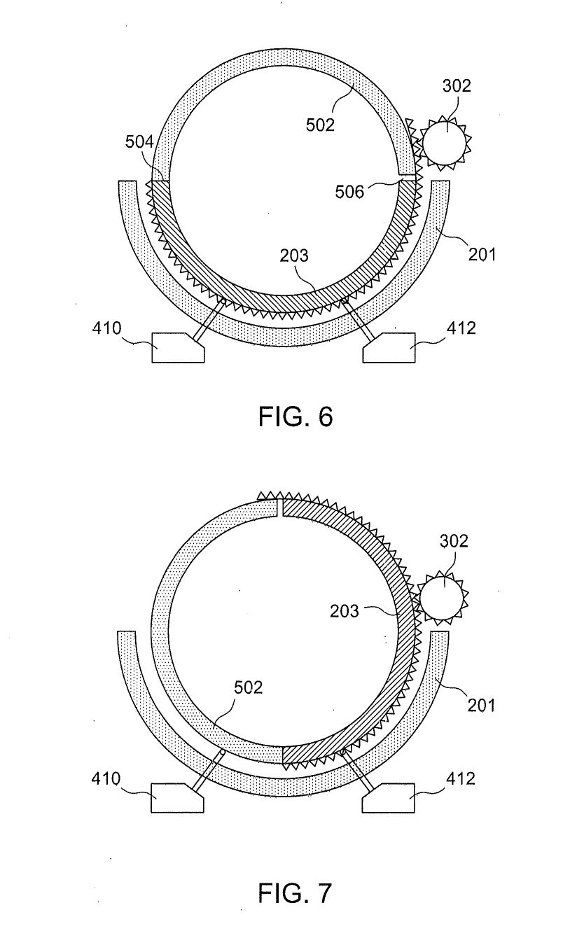

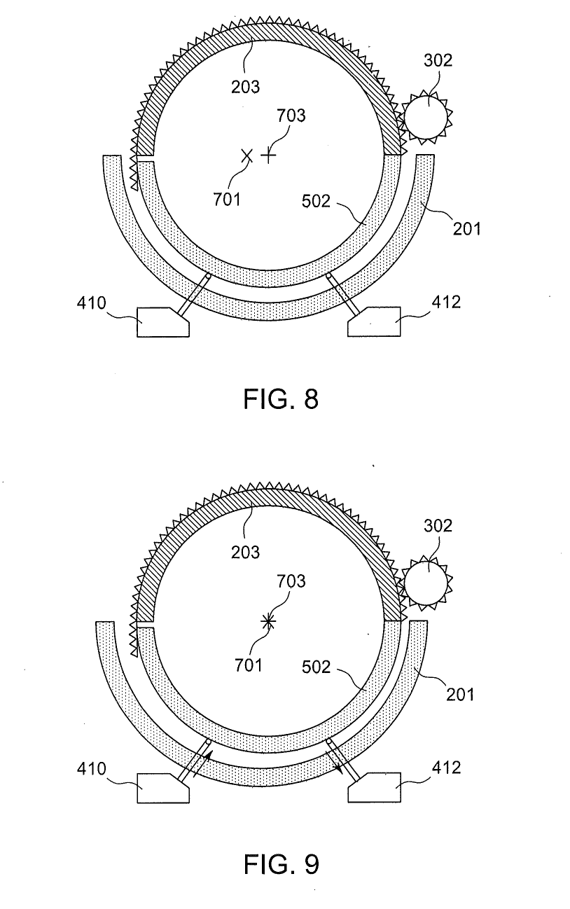

FIGS. 5-8 illustrate a method of roll-in and alignment of an inner turbine shell using the exemplary apparatus of the present disclosure. FIG. 5 shows an axial view of the exemplary outer turbine shell 201 and counterweight 203. A pair of roller jacks 410 and 412 is disposed on opposing sides of the outer turbine shell. The counterweight 203 can be therefore be elevated away from the outer turbine shell 201 using the exemplary roller jacks 410 and 412. In FIG. 6, a lower half of an inner turbine shell 502 is placed in an inverted position on the counterweight 203 and secured to the counterweight 203 at the faces 504 and 506. The counterweight 203 and inner turbine shell 502 are separated away from the outer turbine shell 201 by extension of the roller jacks 410 and 412, thus enabling the rotation of the counterweight/inner turbine shell assembly within the outer turbine shell. FIG. 7 shows the counterweight 203 and the inner turbine shell 502 rotated counterclockwise via the motive gear 302. FIG. 8 shows the result of continuing the rotating demonstrated in FIG. 7. The inner turbine shell 502 is now in place within the outer turbine shell 201. The counterweight 203 can now be removed and the upper halves of the inner turbine shell and the outer turbine shell can be coupled to their lower halves seen in FIG. 8. Whereas the sequence shown in FIGS. 5-8 demonstrates rolling in of the inner turbine shell, rolling out of the inner turbine shell is performed by reversing this sequence.

FIG. 8 further shows a centerline 701 of the inner turbine shell 502 as well as central rotor axis 703. During operation of the turbine, the centerline 701 of the inner turbine shell and the rotor line are aligned to ensure operation within tolerances and gap clearances between rotor tips and an inner turbine shell surface. As shown in FIG. 8, the centerline 701 is not along the same axis as the rotor. The members 104 of the roller jacks can be manipulated to align the centerline 701 with the rotor axis 703, as illustrated in FIG. 9.

FIG. 9 illustrates a method of alignment of a centerline of an inner turbine shell with a rotor axis using the exemplary apparatus of the present disclosure. In the example of FIG. 9, roller jack 410 is extended along the direction indicated by its associated arrow while roller jack 412 is retracted along the direction indicated by its associated arrow, thereby shifting the centerline 701 to be substantially on top of the rotor axis 703.

The apparatus of the present disclosure therefore combines the roller bearings used during installation of the inner turbine shell with the hydraulic jacks used for positioning and alignment of the inner turbine shell and rotor. Thus, use of the exemplary apparatus reduces outage time and increases flexibility in the installation/alignment process.

Therefore, in one aspect, the present disclosure provides a method of rolling and aligning a casing of a gas turbine, including: positioning at least one jack having a roller at one end to a location to couple the roller to the casing; rolling the casing over the roller; and moving the roller relative and to the at least one jack to align the casing. In one embodiment, the at least one jack further comprises a first jack having a roller and a second jack having a roller. The method generally includes actuating a drive system to roll the casing over the roller. In one embodiment, the method further includes coupling a portion of the casing to the drive system and transmitting a torque from the drive system to the counterweight gear to roll the casing over the roller. The at least one jack generally includes a housing and a member axially movable within a housing having the roller thereon, further comprising moving the member relative to the housing to move the roller. In one embodiment, aligning the casing further comprises aligning a center line of the casing with a central rotor line of the gas turbine. The member is configured to move substantially along a radial line of the casing. In various embodiments, the roller includes two or more rollers. Rolling the inner turbine shell can be part of: (i) a process of assembling the gas turbine; and (ii) a process of disassembling the gas turbine.

In another aspect, the present disclosure provides an apparatus for rolling and aligning a casing of a gas turbine, including: at least one jack configured to couple to the casing at a contact point and to move the casing to align the casing; and a roller at an end of the at least one jack at the contact point configured to roll the casing. The at least one jack can include a first jack having a roller and a second jack having a roller in various embodiments. A drive system can be configured to control the rolling of the inner turbine shell. A counterweight can be configured to couple to a portion of the inner turbine shell, wherein the counterweight configured to couple to the drive system to cause the casing to roll. The drive system can be a motive gear, a friction drive or a chain drive in various embodiments. In an exemplary embodiment, the at least one jack includes: a housing; a member configured to move axially with respect to the housing; and the roller at an end of the member distal to the housing. The member is configured to move with respect to the housing to align a center line of the casing with a central rotor line of the gas turbine. The member is configured to move substantially along a radial line of the casing. In various embodiments, the roller includes two or more rollers. In exemplary embodiments, the at least one jack and the roller is configured to roll the casing as part of: (i) assembling a gas turbine assembly; and (ii) disassembling the gas turbine assembly. The casing can be an inner turbine shell an inner compressor casing, in various embodiments.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of rolling and aligning a casing of a gas turbine, comprising:
positioning at least one jack having a roller at one end to a location to couple the roller to the casing;
rolling the casing over the roller; and
moving the roller relative to the at least one jack to align the casing.

2. The method of claim 1, wherein the at least one jack further comprises a first jack having a roller and a second jack having a roller.

3. The method of claim 1, further comprising actuating a drive system to roll the casing over the roller.

4. The method of claim 3, further comprising coupling a portion of the casing to a counterweight coupled to the drive system and transmitting a torque from the drive system to the counterweight gear to roll the casing over the roller.

5. The method of claim 1, wherein the at least one jack includes a housing and a member axially movable within a housing having the roller thereon, further comprising moving the member relative to the housing to move the roller.

6. The method of claim 5, wherein the member is configured to move substantially along a radial line of the casing.

7. The method of claim 1, wherein aligning the casing further comprises aligning a center line of the casing with a central rotor line of the gas turbine.

8. The method of claim 1, wherein the roller includes two or more rollers.

9. The method of claim 1, further comprising rolling the casing as part of: (i) a process of assembling the gas turbine; and (ii) a process of disassembling the gas turbine.

10. An apparatus for rolling and aligning a casing of a gas turbine, comprising:
at least one jack configured to couple to the casing at a contact point and to move the casing to align the casing; and
a roller at an end of the at least one jack at the contact point configured to roll the casing.

11. The apparatus of claim 10, wherein the at least one jack further comprises a first jack having a roller and a second jack having a roller.

12. The apparatus of claim 10, further comprising a drive system configured to control the rolling of the casing.

13. The apparatus of claim 12, further comprising a counterweight configured to couple to a portion of the casing, wherein the counterweight is configured to couple to the drive system to cause the casing to roll.

14. The apparatus of claim 12, wherein the drive system is selected from the group consisting of: (i) a motive gear; (ii) a friction drive; and (iii) a chain drive.

15. The apparatus of claim 10, wherein the at least one jack includes:
a housing;
a member configured to move axially with respect to the housing; and
the roller at an end of the member distal to the housing.

16. The apparatus of claim 15, wherein the member is configured to move with respect to the housing to align a center line of the casing with a central rotor line of the gas turbine.

17. The apparatus of claim 15, wherein the member is configured to move substantially along a radial line of the casing.

18. The apparatus of claim 10, wherein the roller includes two or more rollers.

19. The apparatus of claim 10, wherein the roller is further configured to roll the casing as part of: (i) assembling a turbine assembly; and (ii) disassembling the turbine assembly.

20. The apparatus of claim 10, wherein the casing is at least one of: (i) an inner turbine shell; and (ii) an inner compressor casing.
